(19) United States
(12) Patent Application Publication
(10) Pub. No.: US 2013/0326602 A1
(43) Pub. Date: Dec. 5, 2013

(54) Digital Signatures

(71) Applicant: Liqun Chen, Bristol (GB)

(72) Inventor: Liqun Chen, Bristol (GB)

(73) Assignee: HEWLETT-PACKARD DEVELOPMENT COMPANY, L.P., Houston, TX (US)

(21) Appl. No.: 13/985,265

(22) PCT Filed: May 2, 2011
(86) PCT No.: PCT/US2011/034804

§ 371 Date: Aug. 13, 2013

Related U.S. Application Data
(60) Provisional application No. 61/445,238, filed on Feb. 22, 2011.

(51) Int. Cl. H04L 29/06

(52) U.S. Cl. CPC H04L 63/08
USPC 726/6

(57) ABSTRACT

Apparatus and methods of creating digital signatures include storing a credential received from an external issuing entity at a host device associated with a signature engine. After agreeing on a message with a verifying entity, the host device may transmit a version of the credential with a signature from the associated signature engine for the message to the verifying entity. The verifying entity may determine from the version of the credential and the digital signature whether the credential originated from a trusted issuing entity.

### CROSS-REFERENCE TO RELATED APPLICATIONS

The present application claims priority under 35 U.S.C. §119(e) to United States Provisional Patent Application Ser. No. 61/445238, which was filed on Feb. 22, 2011.

### BACKGROUND

A digital signature is typically generated by a trusted entity for content using a private key held by the trusted entity. When the content has been signed with the digital signature, an entity receiving the content with the digital signature may use a public key for the trusted entity to verify that the trusted entity signed the received content. If the verifying entity does not directly trust the signing entity, then a trusted third party may introduce the signing entity's public key by providing a digital credential (also called a digital certificate) associated with the signing entity's public key under the third party's own private key.

Some systems using digital signatures rely on the anonymity of signing entities to preserve the integrity of system security. In the context of signer anonymity, most signature schemes fall within three categories, depending on the type of public key used for signature verification. In signature schemes of the first category, a verifier makes use of a public key corresponding to an individual signer to verify a signature from that signer. As such, signature verification in this first category does not provide signer privacy. In signature schemes of the second category, a verifier may make use of a set of public keys, with each public key corresponding to one potential signer in a group of signers. The degree of signer privacy in this type of signature scheme is dependent on the size of the public key set. In a third category of signature schemes, a verifier makes use of a group public key to verify a received signature. In this type of scheme, signer privacy is also held and the level of privacy is dependent on the size of the group. When the size of a group is very large, the third category is often considered to be the most suitable solution.

### BRIEF DESCRIPTION OF THE DRAWINGS

The accompanying drawings illustrate various examples of the principles described herein and are a part of the specification. The illustrated examples are merely examples and do not limit the scope of this disclosure.

FIG. 1 is a block diagram of an illustrative system of anonymous verification, according to one example of principles described herein.

FIG. 2 is a flow diagram of an illustrative method of producing an anonymous digital signature, according to one example of principles described herein.

FIG. 3 is a flow diagram of an illustrative method of verifying a host device, according to one example of principles described herein.

FIG. 4 is a diagram of an illustrative diagram of function calls that may be made to a signature engine, according to one example of principles described herein.

FIG. 5 is a diagram of an illustrative Direct Anonymous Attestation (DAA) join process, according to one example of principles described herein.

FIG. 6 is a diagram of an illustrative (DAA) signature verification process, according to one example of principles described herein.

FIG. 7 is a diagram of an illustrative group signature join process, according to one example of principles described herein.

FIG. 8 is a diagram of an illustrative group signature verification process, according to one example of principles described herein.

FIG. 9 is a block diagram of an illustrative computing device that implements an issuing entity, a host device, and/or a verifying entity, according to one example of principles described herein.

Throughout the drawings, identical reference numbers may designate similar, but not necessarily identical, elements.

### DETAILED DESCRIPTION

As described above, significant demand exists for effective anonymous digital signature (ADS) schemes in digital systems. However, most if not all existing anonymous digital signature schemes are specially designed, complex schemes that require significantly more resources to implement than ordinary (i.e., non-anonymous) signature schemes.

The present specification describes systems, methods, and computer program products for utilizing an ordinary cryptographic device that produces non-anonymous digital signatures, referred to as a signature engine, in connection with a host device to create signer anonymous digital signatures of content.

A “signature engine” may be an autonomous hardware device or module that outputs a digital signature for a message using a private key held by the signature engine. The message may be generated by the signature engine or received from an external entity, such as a host device or a signature verifier.

A “host device” may be an electronic processor-based apparatus that associates with a signature engine, the host device providing input to and receiving output from the signature engine.

An “issuing entity” or “issuer” may be a trusted electronic device or process that provides trusted digital credentials associated with a signature engine to a host device.

A “verifying entity” or “verifier” may be an electronic device that communicates with a host device and determines whether digital credentials associated with the host device are valid.

In the following description, for purposes of explanation, numerous specific details are set forth in order to provide a thorough understanding of the present systems and methods. It will be apparent, however, to one skilled in the art that the present apparatus, systems and methods may be practiced without these specific details. Reference in the specification to “an example” or similar language means that a particular feature, structure, or characteristic described in connection with that example is included as described, but may not be included in other examples.

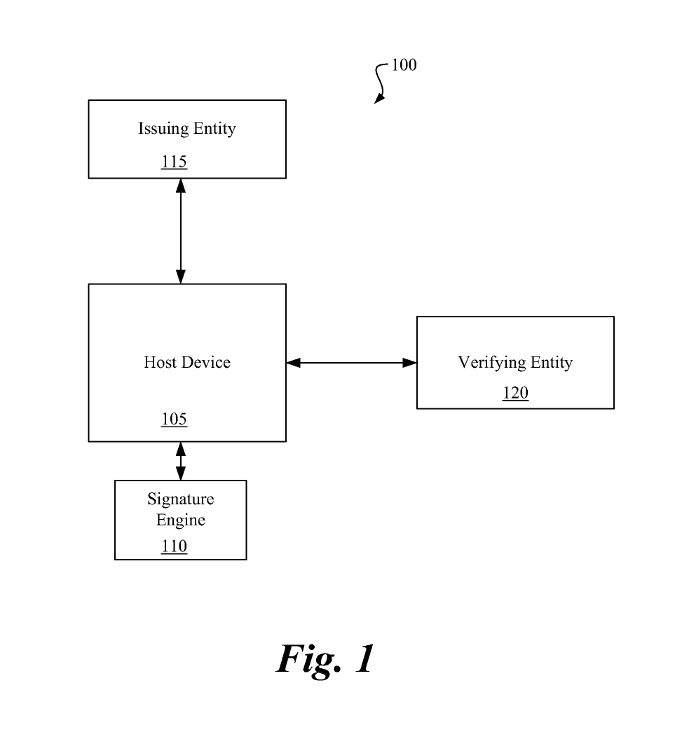

Referring now to FIG. 1, a block diagram of an illustrative system (100) of anonymous verification is shown. The system (100) includes a host device (105) associated with a signature engine (110), an external issuing entity (115), and an external verifying entity (120). The host device (105) may communicate with the issuing entity (115) and the verifying entity (120) over a network. In certain examples, the host device (105) may receive digital credentials from the issuing entity (115). As will be explained in more detail below, the host device (105) and signature engine (110) may generate an anonymous digital signature and transmit the anonymous digital signature to the verifying entity (120) as evidence of the credentials received from the issuing entity (115). If the issuing entity (115) is trusted by the verifying entity (120), the verifying entity (120) may infer trust in the host device (105) based on the verified credentials provided by the host device (105).

The signature engine (110) may be any of a number of tamper-resistant hardware devices with a digital signing functionality. This digital signing functionality enables the signature engine (110) to create an ordinary digital signature by using a standard digital signature function. Any standard digital signature function may be used, including but not limited to: Digital Signature Algorithm (DSA); Elliptic Curve Digital Signature Algorithm (EC-DSA); Schnorr Digital Signature Algorithm (SDSA); Elliptical Curve Schnorr Digital Signature Algorithm (EC-SDSA); Rivest, Shamir, and Adleman (RSA), and the like.

Examples of hardware devices that may be used as the signature engine (110) include but are not limited to: Trusted Platform Modules (TPMs), Smart Cards (SCs), Cryptographic Co-processors (CCs) and Radio Frequency Identification (RFID) chips and tags. These cryptographic devices are typically simple, inexpensive, and reasonably secure.

The present specification describes illustrative systems and methods for using a single signature engine (110) to create an Anonymous Digital Signature (ADS), such as a group signature or a DAA signature. In these systems and methods, the signature engine (110) is closely connected with a computer platform, which is the host device (105). In certain examples, the signature engine (110) may be bound with the hardware platform of the host device (105) (e.g., a TPM). Additionally or alternatively, the signature engine (110) may be attached with the platform of the host device (105) (e.g., a Smart Card or an RFID chip) or embedded in the platform of the host device (105) (e.g., a CC). Generally speaking, because the signature engine (110) is a hardware-based device, its resources are expensive and dependent on the type of signature scheme used. Any technique to reduce the requirement on its resources is, therefore, valuable.

In the present specification, for each Anonymous Digital Signature scheme, a signer role is split between two entities: the signature engine (110) and the host device (105). The signature engine (110) holds a private signing key and creates standard non-anonymous digital signatures, independent of the real applications where a specific anonymous signature is required. The host device (105) holds a membership credential issued by the issuing entity (115), and uses the signature engine (110) to create various anonymous signatures. Without the aid of the signature engine (110), the host device (105) is not able to make any valid signature, and the host device (105) is responsible for protecting privacy of the signature engine (110). This is reasonable, as the host device (105) typically represents the owner of the platform and is therefore charged with protecting the anonymity of the owner and the components of the platform.

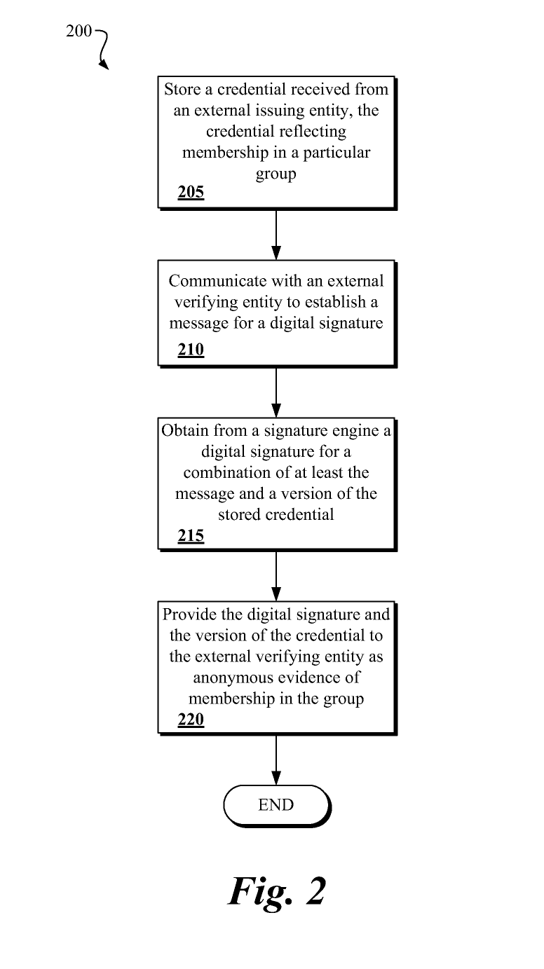

FIG. 2 shows a block diagram of an illustrative method (200) of producing an anonymous digital signature, according to one example of principles described herein. The method (200) may be performed, for example, by a host device (105) associated with a signature engine (110), as described in relation to FIG. 1. In the method (200), the host device stores (block 205) a credential received from an external issuing entity. The credential is associated with the signature engine (110), and reflects membership in a particular group. The credential may include a signature generated by the issuing entity using a private key possessed by the issuing entity. In certain examples, the credential may be a signature generated by the issuing entity for a private or public key possessed by the signature engine (110).

In certain examples, the host device may receive the credential from the issuing entity only after the issuing entity has verified the signing ability of the signature engine associated with the host device. For example, the host device may received a challenge message from the issuing entity, obtain a signature for the challenge message from the corresponding signature engine, and transmit the signature for the challenge message and a public key for the signature for the challenge message back to the issuing entity. Once the issuing entity has checked the signature for the challenge message for accuracy, the issuing entity may provide the host device with the credential.

The host device communicates (block 210) with an external verifying entity to establish a message for a digital signature. For example, the host device and the external verifying entity may agree on a random string of bits produced by the external verifying entity as the message.

The host device may then obtain (block 215) from the corresponding signature engine a digital signature for a combination of at least the message and a version of the stored credential. The version of the stored credential may be, for example, a scaled version of the credential in which each element of the credential has been scaled by a randomly selected integer. The host device may communicate with the verifying entity to determine a base parameter which the host device provides to the signature engine for generating the digital signature and its corresponding public and private keys. This digital signature, together with the version of the credential, are provided (block 220) to the external verifying entity as anonymous evidence of the host device's membership in the group.

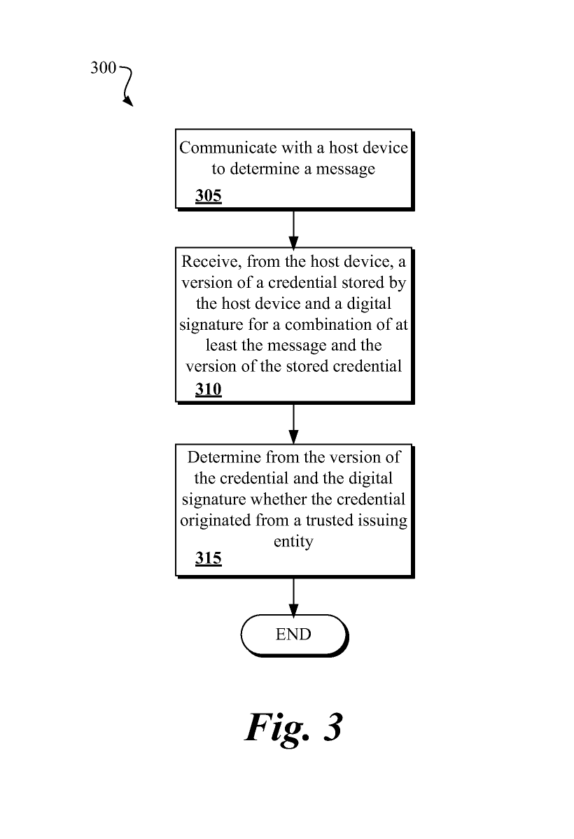

FIG. 3 is a flowchart diagram of an illustrative method (300) of verifying a host device, according to one example of principles described herein. The method (300) may be performed by, for example, a verifying entity that communicates with a host device to determine whether the host device is a member of a particular group. In the method (300), the verifying entity communicates (block 305) with the host device to determine a verification message. The verification message may be, for example, a random string of digital bits (i.e., a nonce) produced by either the host device or the verifying entity. Alternatively, the signature engine may be asked to generate the verification message internally, e.g. the verification message is a new key and the anonymous digital signature is an anonymous digital certificate of the key. After the host device and the verifying entity agree on the message, the verifying entity receives (block 310) from the host device a version of a credential stored by the host device and a digital signature for a combination of at least the message and the version of the stored credential. The version of the stored credential may be a randomized version of the credential in which each element of the credential has been multiplied by a randomly selected integer. The version of the stored credential may include a version of a public key from a signature engine associated with the host device. The signature received from the host device may have been produced by the signature engine associated with the host device.

The verifying entity may determine (block 315) from the version of the credential and the digital signature whether the credential stored by the host device originated from a trusted issuing entity. In some examples, the verifying entity may also be able to determine from the version of the credential and the digital signature whether the signature engine associated with the host device is distrusted without knowing the exact identity of the signature engine.

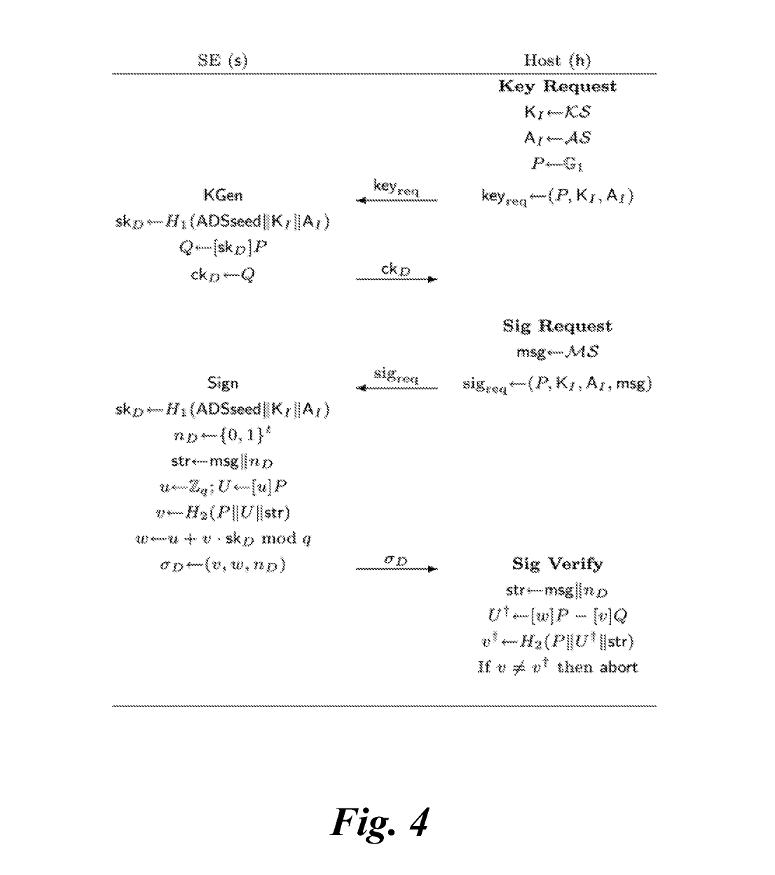

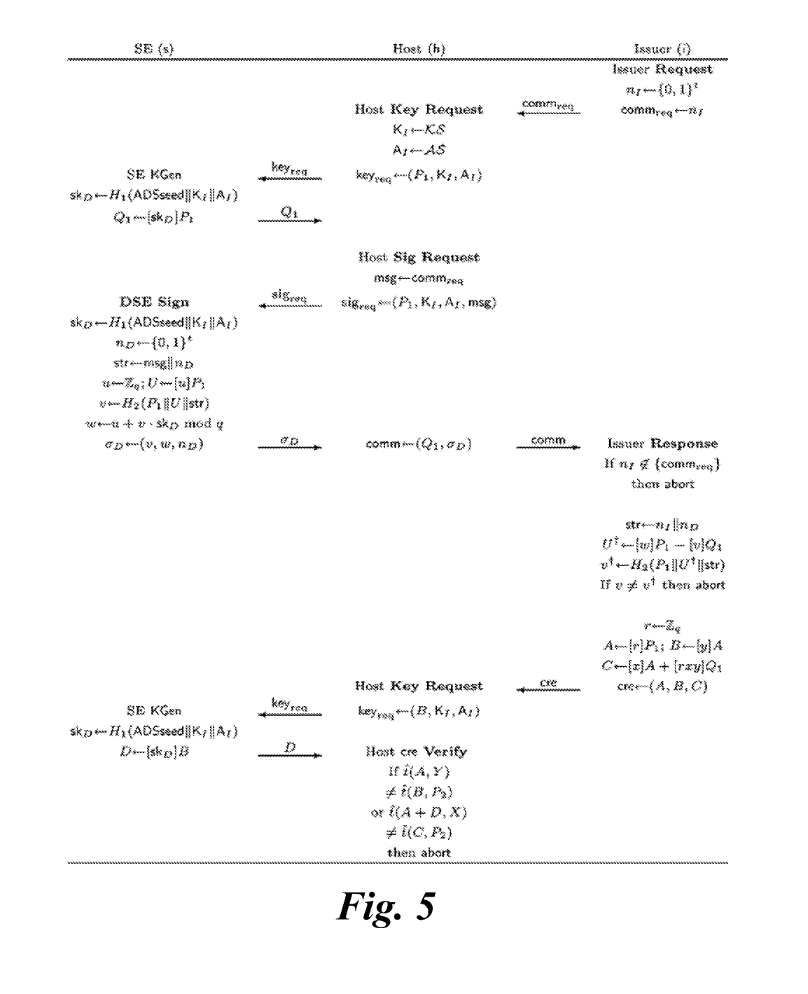

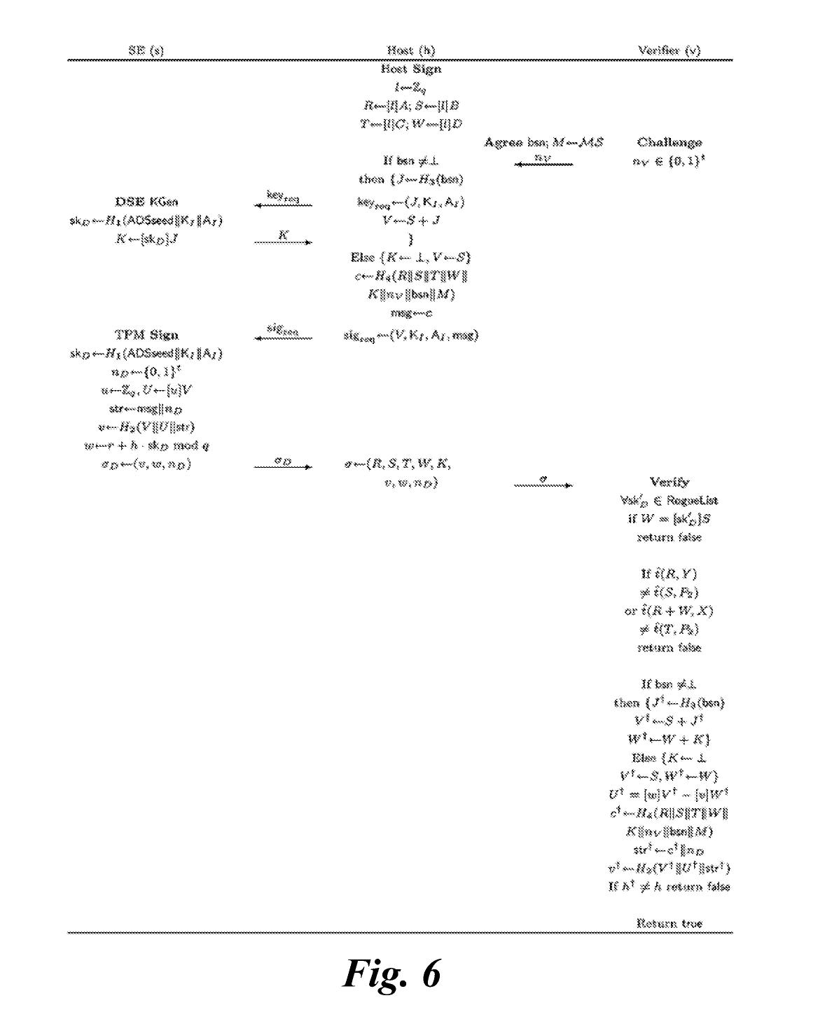

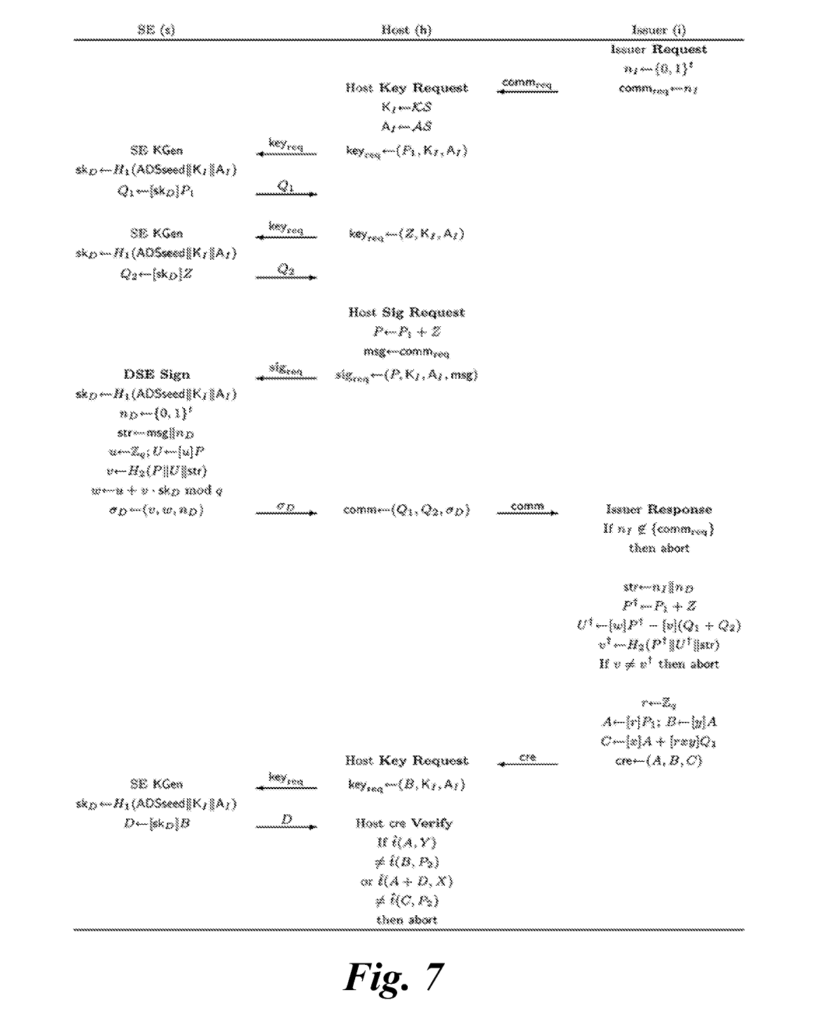

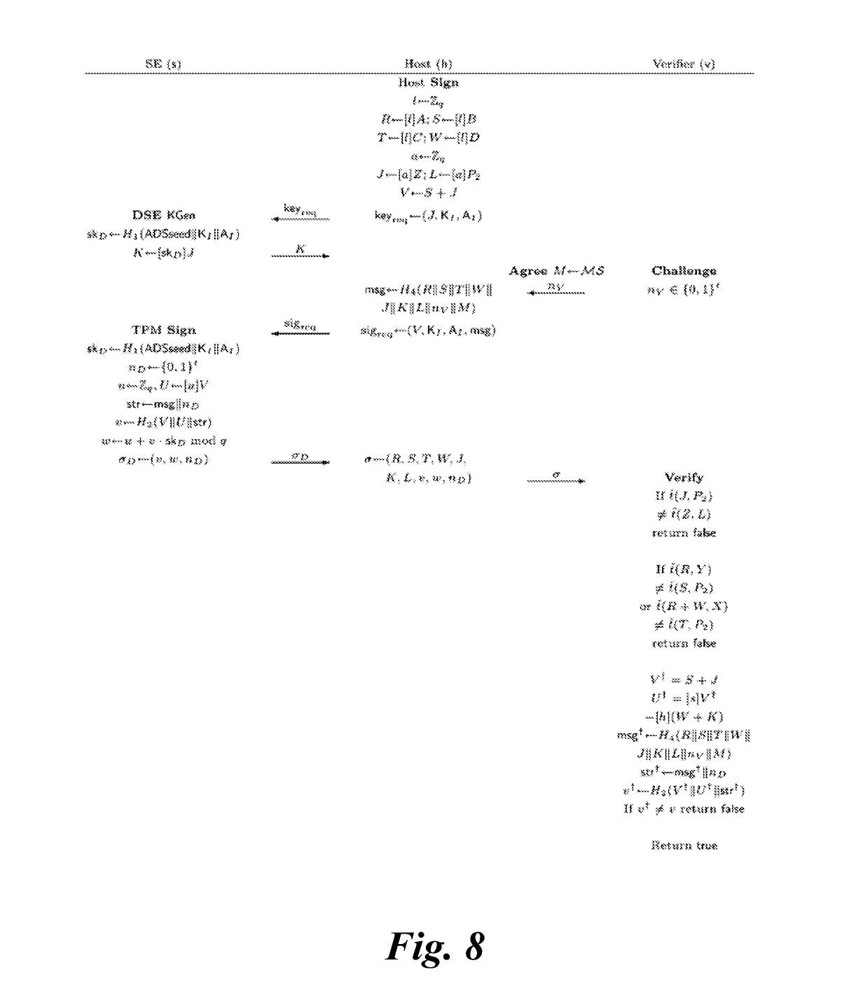

FIGS. 4-8 illustrate examples of the application of the above principles to produce and verify anonymous digital signatures. FIG. 4 illustrates the functions of an illustrative signature engine. FIG. 5 shows an illustrative process of receiving credentials in a host device from an issuing entity of a Direct Anonymous Attestation (DAA) signature system. FIG. 6 shows an illustrative process of producing and verifying anonymous digital signatures in the DAA signature system of FIG. 5. FIG. 7 shows an illustrative process of receiving credentials in a host device from an issuing entity of an anonymous group signature system. FIG. 8 shows an illustrative process of producing and verifying anonymous digital signatures in the DAA signature system of FIG. 7.

Throughout FIGS. 5-8, the following standard notation is used:
If S is a set, x←S denotes the act of sampling from S uniformly at random and assigning the result to the variable x.
{0, 1}* and {0, 1}^{t} denote the set of binary strings of arbitrary length and length t, respectively.
If A is an algorithm, x←A(y₁, . . . , yₙ) denotes the action of obtaining x by invoking A on inputs y₁, . . . , yₙ.
x∥y denotes the concatenation of two date strings x and y.
X [symbol] Y denotes a function that maps a set X to another set Y.
For a general cyclic group [symbol] , g^{x}∈ [symbol] (or simply g^{x}) denotes the exponentiation of a group element g by some integer exponent x.
For an elliptic curve based cyclic group [symbol] , [x]P∈ [symbol] (or simply [x]P) denotes the scalar multiplication of an elliptic curve point P by some integer x.

The security of the examples given in FIGS. 4-8 is based on asymmetric pairings. These examples may avoid the poor security level scaling problem in symmetric pairings and may allow one to implement the DAA and group signature schemes efficiently at high t security levels. Throughout FIGS. 4-8, [symbol] =(P), [symbol] =(Q), and [symbol] are groups of large prime exponent p≈2^{t} for security parameter t. All the three groups will be written multiplicatively. If [symbol] is some group then the notation [symbol] means the non-identity elements of [symbol] .

A pairing (or bilinear map) is a map ŝ: [symbol] × [symbol] → [symbol] such that:
1. The map \hat{t} is bilinear. This means that cP,P′∈ [symbol] and vQ,Q′∈ [symbol]
   \hat{t}(P·P¹,Q)=\hat{t}(P,Q)·\hat{t}(P¹,Q)∈ [symbol] ; and
   ŝ(P,Q·Q¹)=\hat{t}(P,Q)·\hat{t}(P,Q¹)∈ [symbol] .
2. The map \hat{t} is non-degenerate. This means that
   vP∈ [symbol] ∃Q∈ [symbol] such that \hat{t}(P,Q)˜1_{G}_{_{T}}∈ [symbol] ; and
   vQ∈ [symbol] ∃P∈ [symbol] such that \hat{t}(P,Q)˜1_{G}_{_{T}}∈ [symbol] .
3. The map \hat{t} is computable, that is, there exists some polynomial time algorithm to compute \hat{t}(P,Q)∈ [symbol] for all (P,Q)∈ [symbol] × [symbol] .

Before proceeding with a more specific explanation of the examples of FIGS. 4-8, it should be understood that in certain examples, every group element received by any entity may be checked for validity, i.e., that it is within the correct group. In particular, it may be important that the element does not lie in some larger group which contains the group in question. Enforcing this strict stipulation may avoid numerous attacks such as those related to small subgroups, to which some signature schemes based on asymmetric pairings may be vulnerable without proper precautions.

Referring now to FIG. 4, the functionality of an illustrative signature engine that implements a Schnorr signature scheme is shown. The illustrative signature engine implements two main functions: a key generation function (KGen) and a signing function (Sign).

The key generation function is a deterministic function that takes a key generation request (key_{req}) as input, computes a secret key (private) sk_{D} and a committed key ck_{D}, and then outputs the committed (public) key ck_{D}. Each key_{req} is informed with three elements: P, Kₗ, and Aₗ. P is a base parameter for computing the key, Kₗ is key information, and Aₗ is algorithm information. Because the signature engine may be used for multiple applications and anonymous digital signatures, Aₗ may be used to distinguish between these applications and signature schemes. Kₗ indicates the group [symbol] , such as P∈ [symbol] , the group order q, and any other parameter received by the signature engine to calculate the key. Kₗ must be sufficient for the signature engine to be able to verify whether P is an element of the given group [symbol] and to compute the secret key sk_{D}∈ [symbol] and and the committed key ck_{D}∈ [symbol] . The secret key sk_{D} is computed by using a Key Derivation Function (KDF),which, as shown in FIG. 1, is denoted by a secure hash function H₁ on a secret string of bits (ADSseed) known only to the signature engine using Kₗ and Aₗ as input parameters.

The signature engine of FIG. 4 produces a signature σ_{D} using the probabilistic Schnorr signature scheme in response to receiving a signature request (sig_{req}) from the host device. Alternatively, any three-move type of signature scheme (e.g., DSA, EC-DSA, SDSA, EC-SDSA, etc.) may be used to achieve the same security and anonymity. The nonce n_{D} shown in FIG. 4 may be used to guarantee a freshly generated signature, but may be omitted if the signing algorithm involves randomization. The signature includes three elements: v, w, and n_{D}, computed as shown in FIG. 4. As further shown in FIG. 4, the host device may verify the signature received from the signature engine using a public Hash function, public parameters P and Q, and the v, w, and n_{D} parameters received in the signature σ_{D}.

Illustrative DAA Scheme

FIGS. 5-6 illustrate the use of a signature engine implementing the functionality shown in FIG. 4 to execute a Direct Anonymous Attestation (DAA) signature scheme.

In a DAA scheme, an issuing entity is in charge of verifying the legitimacy of signers, and of issuing a DAA credential to each signer. In the examples of the present specification, a signer is a pair of a host device and its associated signature engine. The signer may prove to a verifying entity that the signer holds a valid DAA credential by providing a DAA signature. The verifying entity may verify the DAA credential from the signature without learning the identity of the signature engine. Linkability of signatures issued by a host device-signature engine pair is controlled by an input parameter bsn (standing for “base name”) which is passed to the signing operation. If the bsn parameter is set to a specified constant ⊥, signatures issued by host device-signature engine pair cannot be linked back to the host device-signature engine pair.

To initialize and set up the system, parameters for each protocol as well as the long term parameters for each Issuer and each SE are selected. On input of the security parameter 1^{t}, the Setup function selects three groups [symbol] , [symbol] , and [symbol] , of sufficiently large prime order q; selects two random generators such that [symbol] =(P₁) and [symbol] =(P₂) along with a pairing \hat{t}: [symbol] × [symbol] [symbol] [symbol] . Four hash functions are selected, namely H₁:{0,1}* [symbol] [symbol] , H₂:{0,1}* [symbol] , H_{S}:{0,1}* [symbol] G₁, and H₄:{0,1}* [symbol] [symbol] . The hash-function H₁ is used as the Key Derivation Function (KDF) for the signature engine, as shown in FIG. 4. In the present example, the signature engine operations are limited to [symbol] , which allows Kₗ to be set to ( [symbol] , P₁, q). As described previously, each signature engine has a long-term secret, namely ADSseed←{0,1}^{t}. For each issuing entity, two integers x,y← [symbol] are selected, and the private key of the issuing entity is set to (x, y). Next, the values X=[x]P₂∈ [symbol] and Y=[y]P₂∈ [symbol] are computed, and the issuing entity's public key ipk is set to (X, Y). Finally, the public system parameters par are set to ( [symbol] , [symbol] , [symbol] , \hat{t}, P₁, P₂, q, H₁, H₂, H₃, ipk).

With specific reference to FIG. 5, a DAA join protocol is shown. In the join protocol of FIG. 5, a host device associated with a signature engine obtains credentials from a trusted issuing entity. The credentials may be used to provide anonymous evidence of membership in a group to other entities. The join protocol of FIG. 5 calls for the key generation function of the signature engine twice and the signing function of the signature engine once.

As shown in FIG. 5, the protocol begins with the issuing entity creating a fresh nonce nₗ and sending it to the host device as a commitment request comm_{req}. This nonce is used to guarantee that the response to the request is freshly generated. The host device creates a key request key_{req} using the P₁, Kₗ, and Aₗ parameters and sends the key request to the signature engine as the first call of the key generation function. The signature engine generates a secret (private) key sk_{D} and a committed (public) key Q₁, and returns the committed (public) key to the host device.

The host device then creates a sign request sig_{req} by using comm_{req} as the signed message msg along with the three elements used in the key request. The signature engine computes and returns signature σ_{D} . The nonce n_{D} in comm_{req} guarantees that the signature from the signature engine is different from other signatures. The host device transmits the public key Q₁ and go back to the issuing entity as a response comm to the commitment request comm_{req} from the issuing entity.

The issuing entity checks the returned comm_{req} for accuracy, and performs some checks on the response comm received from the host device. If these checks correctly verify, the issuing entity computes a credential cre and then sends it to the host device. The credential cre from the issuing entity is a signature for a randomly selected message r using the Camenisch-Lyszanskaya signature scheme, which is given by a triple of functions, as follows:
Key Generation: The private key is a pair (x,y∈ [symbol] × [symbol] , the public key is given by the pair (X,Y)∈ [symbol] × [symbol] , where X=xP₂ and Y=yP₂, and P₂ being a publicly known parameter.
Signing: On input of a message m∈ [symbol] the signer generates A∈ [symbol] at random and outputs the signature (A, B, C∈ [symbol] × [symbol] × [symbol] ), where B=yA and c=[x+mxy]A.
Verification: To verify a signature on a message the verifier checks whether \hat{t}(A,Y)=\hat{t}(B,P₂) and \hat{t}(A,X)·\hat{t}(m,B,X)=\hat{t}(C,P₂)
   It should be understood that any other signature scheme may be used to provide a credential to the host device, as may suit a particular application of the principles described herein.

The credential cre received from the issuing entity has three elements (A, B, C). The host device requests a new public key D from the signature engine using the B element of the credential cre. Using D as the message m in the verification function of the Camenisch-Lysyanskaya signature scheme, the host device attempts to verify the credential cre. If the credential cannot be verified, the host device aborts the join process or requests a new credential. If the credential is verified, the host device stores the credential from the issuing entity.

FIG. 6 shows an illustrative DAA sign/verify protocol according to the principles of the present specification. This is a protocol between a given host device-signature engine pair and an external verifying entity. As shown in FIG. 6, the protocol begins with the Host randomizing the DAA credential cre received from the issuing entity from (A, B, C, D) to (R, S, T, W). Cre is randomized by scaling each element (A, B, C, D) by a randomly selected integer. This randomization process may occur for each signature produced by the host device-signature engine pair to increase security.

To create a DAA signature, the host device and verifying entity agree to the content of a message M and the base name bsn. In order to guarantee the freshness of the signature, the verifying entity may create a nonce nᵥ, which is sent to the host device as a challenge. The use of this nonce nᵥ is optional and may only occur if the verifying entity desires the assurance that a signature is fresh. As described above, the value of the basename bsn is indicative of whether the produced signature will be linkable to host device-signature engine pair. If bsn≠⊥, the host device creates a key generation request key_{req} using the parameters J, Kₗ, and Aₗ, where J=H₃ (bsn), and sends the key generation request to the signature engine. The signature engine responds to the key generation request with a public committed key K. The host device also sets V equal to S+J. If the unlinkability is required, bsn=⊥, and K is set to the value of ⊥ and V is set to the value of S.

The host device then performs the fourth hash function H₄ on the concatenation of R, S, T, W, K, nᵥ, bsn, and M to produce a message msg which is passed to the signature engine in a signature request sig_{req} with base parameters V, Kₗ, and Aₗ. In response to the signature request, the host device receives signature σ_{D} containing elements (v, w, and n_{D}). The host device then prepares the DAA signature σ, which includes the elements R, S, T, W, K, v, w, and n_{D}. The DAA signature σ is sent to the verifying entity. The verifying entity is able to determine whether the DAA signature was provided by a compromised signature engine by determining whether any entry of a Rogue list multiplied by S is equal to W. The verifying entity further checks whether the agreed bsn was used correctly. After these two checks pass successfully, the verifying entity verifies whether (R, S, T, W) represent a valid credential and whether the agreed message msg and the verifying entity's fresh nonce nᵥ were correctly signed. In the case of bsn ≠⊥, checking that this data string is also used as the secret discrete logarithm in the committed key ck_{D}=K is also implied.

Illustrative Group Signature Scheme

FIGS. 7-8 illustrate the use of a signature engine implementing the functionality shown in FIG. 4 to execute a group signature scheme. As in the DAA scheme, to initialize the group signature system, parameters are selected for each issuing entity and each signature engine. The setup and initialization process for the group signature scheme of FIGS. 7-8 is similar to the setup and initialization process described for the DAA example of FIGS. 5-6, with the presence of an additional element Z∈ [symbol] .

On input of the security parameter 1^{t} , the Setup function selects three groups [symbol] , [symbol] , and [symbol] , of sufficiently large prime order q; selects three random generators such that [symbol] = [symbol] [symbol] [symbol] =( [symbol] ) and [symbol] = [symbol] [symbol] [symbol] along with a pairing [symbol] [symbol] × [symbol] [symbol] [symbol] . The discrete logarithm between the two generations P₁ and Z, i.e., [symbol] is not known to any signer. Three hash functions are selected, namely, [symbol] , [symbol] , and [symbol] . The hash-function H₁ is used as the Key Derivation Function (KDF) for the signature engine, as shown in FIG. 4. In the present example, the signature engine operations are limited to [symbol] , which allows Kₗ to be set to ( [symbol] , P₁, q). As described previously, each signature engine has a long-term secret, namely [symbol] . For each issuing entity, two integers [symbol] are selected, and the private key of the issuing entity is set to (x, y). Next, the values [symbol] and [symbol] are computed, and the issuing entity's public key ipk is set to (X, Y). Finally, the public system parameters par are set to ( [symbol] , [symbol] , [symbol] , \hat{t}, P₁, P₂, Z, q, H₁, H₂, H₃, ipk).

With specific reference to FIG. 7, a group signature join protocol is shown. In the join protocol of FIG. 7, a host device associated with a signature engine obtains credentials from a trusted issuing entity. The credentials may be used to provide anonymous evidence of membership in a group to other entities. The join protocol of FIG. 5 calls for the key generation function of the signature engine three times and the signing function of the signature engine once.

As shown in FIG. 7, the protocol begins with the issuing entity creating a fresh nonce nₗ and sending it to the host device as a commitment request comm_{req}. This nonce is used to guarantee that the response to the request is freshly generated. The host device creates two key request key_{req} using the parameters P₁, Kₗ, Aₗ, and Z, Kₗ, Aₗ, respectively, and sends the key requests to the signature engine to obtain committed (public) keys Q₁ and Q₂.

The host device then creates a sign request sig_{req} by using comm_{req} as the signed message msg along with P₁, Kₗ, and Aₗ. The signature engine computes and returns signature σ_{D} . The host device transmits the public keys Q₁ and Q₂, back to the issuing entity with σ_{D} as a response comm to the commitment request comm_{req} from the issuing entity.

The issuing entity checks the returned comm_{req} for accuracy, and performs some checks on the response comm received from the host device. If these checks correctly verify, the issuing entity computes a credential cre and then sends it to the host device. The credential cre from the issuing entity is a signature for a randomly selected message r using the Camenisch-Lysyanskaya signature scheme, which is given above with respect to FIG. 5. It should be understood that any other signature scheme may be used to provide a credential to the host device, as may suit a particular application of the principles described herein.

The credential cre received from the issuing entity has three elements (A, B, C). The host device requests a new public key D from the signature engine using the B element of the credential cre. Using D as the message m in the verification function of the Camenisch-Lysyanskaya signature scheme, the host device attempts to verify the credential cre. If the credential cannot be verified, the host device aborts the join process or requests a new credential. If the credential is verified, the host device stores the credential from the issuing entity.

FIG. 8 shows an illustrative group signature sign/verify protocol according to the principles of the present specification. This is a protocol between a given host device-signature engine pair and an external verifying entity. As shown in FIG. 8, the protocol begins with the Host randomizing the credential cre received from the issuing entity from (A, B, C, D) to (R, S, T, W). Cre is randomized by scaling each element (A, B, C, D) by a randomly selected scalar I. Similarly, the opening bases (Z, P₂) are randomized to (J, L) using randomly selected integer a. Optionally, the two random values may be the same, such that I=a in FIG. 8. This randomization process may occur for each signature produced by the host device-signature engine pair to increase security. Additionally, the parameter V is set to S+J.

The host device generates a key request key_{q} for the signature engine using parameters J, Kₗ, and Aₗ. The signature engine responds with public key K. To create a group signature for a verifying entity, the host device and verifying entity agree to the content of a message M. In order to guarantee the freshness of the signature, the verifying entity may create a nonce nᵥ, which is sent to the host device as a challenge. The use of this nonce nᵥ is optional may only occur if the verifying entity desires the assurance that a signature is fresh.

The host device then performs the third hash function H₃ on the concatenation of R, S, T, W, J, K, L, nᵥ, and M to produce a message msg which is passed to the signature engine in a signature request sig_{req} with base parameters V, Kₗ, and Aₗ. In response to the signature request, the host device receives signature σ_{D} containing elements (v, w, and n_{D}). The host device then prepares the group signature σ, which includes the elements R, S, T, W, J, K, L, v, w, and n_{D}. The group signature σ is sent to the verifying entity. The verifying entity verifies whether (R, S, T, W) represent a valid credential and whether the agreed message msg and the verifying entity's fresh nonce nᵥ were correctly signed.

Illustrative Computing Device

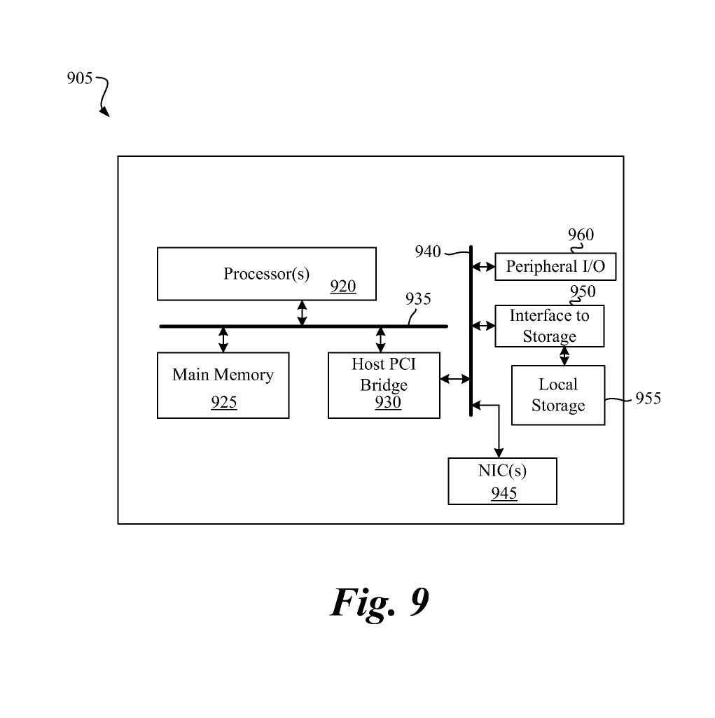

FIG. 9 is a block diagram of an illustrative computing device (905) that may be used to implement any of the issuing entity, the host device, and the verifying entity in an anonymous digital signature scheme consistent with the principles described herein.

In this illustrative device (905), an underlying hardware platform executes machine-readable instructions to exhibit a desired functionality. For example, if the illustrative device (905) implements a host device, the machine-readable instructions may include at least instructions for storing a credential received from an external issuing entity, the credential reflecting membership in a particular group; instructions for communicating with an external verifying entity to establish a message for a digital signature; instructions for obtaining from a signature engine associated with the device (905) a digital signature for a combination of at least the message and a version of the stored credential, the signature being generated using a private key possessed by the signature engine; and instructions for providing the digital signature and the version of the credential to the external verifying entity as anonymous evidence of membership in the group.

In another example, if the illustrative device (905) implements a verifying entity, the illustrative device may include machine-readable instructions for communicating with the host device to determine a message; machine-readable instructions for receiving from the host device a version of a credential stored by the host device and a digital signature for a combination of at least the message and the version of the stored credential; and machine-readable instructions for determining from the version of the credential and the digital signature whether the credential originated from a trusted issuing entity.

The hardware platform of the illustrative device (905) may include at least one processor (920) that executes code stored in the main memory (925). In certain examples, the processor (920) may include at least one multi-core processor having multiple independent central processing units (CPUs), with each CPU having its own L1 cache and all CPUs sharing a common bus interface and L2 cache. Additionally or alternatively, the processor (920) may include at least one single-core processor.

The at least one processor (920) may be communicatively coupled to the main memory (925) of the hardware platform and a host peripheral component interface bridge (PCI) (930) through a main bus (935). The main memory (925) may include dynamic non-volatile memory, such as random access memory (RAM). The main memory (925) may store executable code and data that are obtainable by the processor (920) through the main bus (935).

The host PCI bridge (930) may act as an interface between the main bus (935) and a peripheral bus (940) used to communicate with peripheral devices. Among these peripheral devices may be one or more network interface controllers (945) that communicate with one or more networks, an interface (950) for communicating with local storage devices (955), and other peripheral input/output device interfaces (960).

The configuration of the hardware platform of the device (905) in the present example is merely illustrative of one type of hardware platform that may be used in connection with the principles described in the present specification. Various modifications, additions, and deletions to the hardware platform may be made while still implementing the principles described in the present specification.

The preceding description has been presented only to illustrate and describe examples of the principles described. This description is not intended to be exhaustive or to limit these principles to any precise form disclosed. Many modifications and variations are possible in light of the above teaching.

1. An apparatus, comprising:
at least one processor, said processor being communicatively coupled to memory containing machine-readable instructions that cause said processor to:
store a credential received from an external issuing entity, said credential reflecting membership in a particular group;
communicate with an external verifying entity to establish a message for a digital signature;
obtain from a signature engine associated with said apparatus a digital signature for a combination of at least said message and a version of said stored credential, said signature being generated using a private key possessed by said signature engine; and
provide said digital signature and said version of said credential to said external verifying entity as evidence of membership in said group.

2. The apparatus of claim 1, said credential comprising a signature generated by said issuing entity using a private key possessed by said issuing entity.

3. The apparatus of claim 2, said credential comprising a signature generated by said issuing entity for said private key possessed by said signature engine.

4. The apparatus of claim 3, said machine-readable instructions causing said processor to:
communicate with said external verifying entity to determine a base parameter for generating said public key; and
provide said base parameter to said signature engine to obtain said public key.

5. The apparatus of claim 1 said machine-readable instructions causing said processor to select a random integer; such that said version of said credential comprises a scaled version of said credential in which elements of said credential have been scaled by said random integer.

6. An apparatus, comprising:
at least one processor, said processor being communicatively coupled to memory containing machine-readable instructions that cause said processor to:
communicate with said host device to determine a message;
receive from said host device a version of a credential stored by said host device and a digital signature for a combination of at least said message and said version of said stored credential;
determine from said version of said credential and said digital signature whether said credential originated from a trusted issuing entity.

7. The apparatus of claim 6, in which said machine-readable instructions further cause said processor to determine from said version of credential whether a signature engine associated with said host device is distrusted.

8. The apparatus of claim 6, said message comprising a nonce generated by said at least one processor.

9. The apparatus of claim 6, said message comprising a message generated by a signature engine associated with said host device.

10. A method of creating anonymous digital signatures in a system comprising a host device and an associated signature engine, comprising:
storing, at the signature engine, a private signing key;
storing, at the host device, a credential associated with said signature engine reflecting membership in a group;
generating, with the signature engine, a digital signature based on said private signing key and a verification message;
generating, with the host device, an anonymous digital signature based on said credential and said digital signature generated by said signature engine; and
initiating transmission of said anonymous digital signature to a verifying entity.

11. The method of claim 10, said credential comprising a signature generated by an external issuing entity using a private key possessed by said issuing entity.

12. The method of claim 11, further comprising said host device obtaining said credential from said issuing entity by:
receiving a challenge message from said issuing entity; and
transmitting a signature generated for said challenge message by said signature engine and a public key for said signature generated for said challenge message to said issuing entity for verification.

13. The method of claim 12, further comprising said signature engine using a public base parameter to generate said public key.

14. The method of claim 10, said credential comprising a signature generated by an external issuing entity for said private signing key stored by said signature engine.

15. The method of claim 10, further comprising selecting a random integer; said version of said credential comprising a scaled version of said credential in which elements of said credential have been scaled by said random integer.
